(19) United States
(12) Patent Application Publication
(10) Pub. No.: US 2015/0361959 A1
(43) Pub. Date: Dec. 17, 2015

(54) ADJUSTED OPERATING TIME

(71) Applicant: Theo DU PLESSIS, Den Bosch (NL)

(72) Inventor: Theo DU PLESSIS, Den Bosch (NL)

(73) Assignee: Aktiebolaget SKF, Göteborg (SE)

(21) Appl. No.: 14/762,226

(22) PCT Filed: Jan. 21, 2013
(86) PCT No.: PCT/EP2013/051059

§ 371 Date: Jul. 21, 2015

(51) Int. Cl. F03D 7/04; G05B 23/02

(52) U.S. Cl. CPC F03D 7/042; G05B 23/0283

(57) ABSTRACT

A method for determining an adjusted operating time of a component in a rotating system, the method comprising steps of: during operation of the rotating system, measuring a value of an operating characteristic of a component for a predetermined period of time, determining an average of the measured value of the operating characteristic for the predetermined period of time, determining a ratio of the average and a maximum value of the operating characteristic, and determining the adjusted operating time as the product of the ratio and the predetermined period of time. The method is also adapted to a system.

### CROSS REFERENCE TO RELATED APPLICATIONS

This is a United States National Stage Application claiming the benefit of International Application Number PCT/EP2013/051059 filed on 21 Jan. 2013 (21.01.2013), which is incorporated herein by reference in its entirety.

### FIELD OF THE INVENTION

The present invention relates to large-scale rotating systems. In particular, the present invention relates to a method and a system for determining an operating time of a component in a large-scale rotating system.

### TECHNICAL BACKGROUND

Large-scale rotating systems with blades connected to a main shaft have been used for a long time. An example of a field of technology with large-scale rotating systems is the field of horizontal axis wind turbines. It is furthermore known to control the pitch (longitudinal rotational state) of the blades during operation in order to optimize the efficiency of operation of the rotating system.

For a given wind condition, controlling the pitch can be used to control the load and speed of the wind turbine. In turn, the load and speed of the wind turbine determines the amount of wear on components in the wind turbine such as axles, bearings, gearbox and generator.

In order to improve the availability/up-time and life span of, for example, a wind turbine, various system and bearing related parameters may be monitored, such as, for example, rotational velocity, vibrations, lubricant pressure, lubricant quality, lubricant temperature and bearing load.

Although the monitoring that is currently described in the art helps the scheduling of maintenance and prediction of failures before they occur, and thereby may improve the availability of wind turbines and other similar rotating systems, failure modes that are not detected in time may still exist.

### SUMMARY OF THE INVENTION

In view of the above-mentioned desired properties of for example a wind turbine, it is an object of the present invention to provide an improved method for monitoring components by determining an adjusted operating time for a component in a rotating system.

According to a first aspect of the invention, it is therefore provided a method for determining an adjusted operating time of a component in a rotating system, the method comprising the steps of, during operation of the rotating system, measuring a value of an operating characteristic of a component for a predetermined period of time, determining an average of the measured value of the operating characteristic for the predetermined period of time, determining a ratio of the average and a maximum value of the operating characteristic, and determining the adjusted operating time as the product of the ratio and the predetermined period of time.

The present invention is based on the realization that it is advantageous to determine an adjusted operating time of a component in a rotating system in order to more accurately determine the need for service or replacement of the component. Additionally, an adjusted operating time, which is different from the actual operating time, may help to identify why the life length of components in different systems varies even though the actual operating time appears to be the same. The adjusted operating time is determined based on an operating characteristic influencing the life length of a component. Thereby, the adjusted operating time takes into account not only the time of operation but also specific operating conditions for the component and for the system as a whole. The maximum value of an operating characteristic, which may be regarded as a tolerance limit, can typically be a predetermined value based on simulations, modeling or empirical data. Accordingly, the adjusted operating time is based on the actual operating conditions for a component in relation to the tolerance limit of the component in respect the particular characteristic. As an example, if a value of an operating characteristic is determined to have an average of 50% of its maximum value for an operating time of one hour, the adjusted operating time is 0.5 hours.

According to one embodiment of the invention the method may further comprise the steps of, during operation of the rotating system, measuring a value of a second operating characteristic of a component for the predetermined period of time, determining a second average of the measured value of the second operating characteristic for the predetermined period of time, determining a second ratio as the ratio of the second average and a maximum value of the second operating characteristic, and determining an adjusted operating time as the product of the first ratio, the second ratio and the predetermined period of time. By measuring more than one operating characteristic simultaneously, and by determining the adjusted operating time based on more than one operating characteristic per cycle of the component, the adjusted operating time will more accurately reflect the practical life span of the component under the “in life” operating conditions.

In one embodiment of the invention the method may further comprise the step of determining an accumulated adjusted operating time of said component by adding a determined adjusted operating time to previously determined adjusted operating time.

According to various embodiments of the invention, the operating characteristic may be a rotational velocity, a mechanical load or a vibration of the component. There are several operating characteristics which influence the wear on components on a large scale rotating system, and the aforementioned are among the more important. Using the main bearing in a wind turbine as an example, rotational velocity of the main axis, the load on the main bearing and overall vibrations in the system are influencing the life length of the bearing. Accordingly, it is important to be able to as accurately as possible determine the operating conditions for the bearing, and to be able to predict when the bearing nears the end of its life length. Thereby, the bearing may be replaced prior to failure and expensive and time-consuming repairs can be avoided. Similarly, a reduction of cost can be achieved by avoiding prematurely replacing components based only on the actual operating time. Other examples of relevant components include axles, rotor blades, gear box and generator.

In one embodiment of the invention, the value of an operating characteristic of a component may be measured continuously during operation of said rotating system. Alternatively, the value of the characteristic may be measured or sampled at predetermined time intervals.

According to a second aspect of the invention, there is provided an arrangement for determining an adjusted operating time of a component in a rotating system, the system comprising: a sensor configured to detect a value of an operating characteristic of a component, and a control unit connected to the sensor and configured to: during operation of the rotating system, acquire a value of the operating characteristic of a component from the sensor for a predetermined period of time, determine an average of the acquired value of the operating characteristic for the predetermined period of time, determine a ratio of the average and a maximum value of the operating characteristic, and determine the adjusted operating time as the product of the ratio and the predetermined period of time.

In one embodiment of the invention, the sensor may be a sensor for detecting a rotational velocity, a mechanical load or a vibration of said component. For example, an accelerometer may be used for measuring rotational velocity and vibration, and a strain gauge may be used to measure mechanical load. However, a wide range of sensors known by the person skilled in the art may be used. Furthermore, in a wind turbine, the mechanical load of components can be determined based on the power output of the generator (generator load).

In one embodiment of the invention, the aforementioned arrangement may comprise communication means for transmitting any of the measured value of the characteristic, the average, the ratio and the adjusted operating time or adjusted operating load to a remote location. Thereby, the operation of the rotating system may be monitored remotely.

Additionally the arrangement for determining an adjusted operating time of a component may advantageously be comprised in a wind turbine for operating in real time.

Further effects and features of this second aspect of the present invention are largely analogous to those described above in connection with the first aspect of the invention.

Additional features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

These and other aspects of the present invention will now be described in more detail with reference to the appended drawings showing an example embodiment of the invention, wherein:

FIG. 1 schematically illustrates an exemplary wind turbine according to an embodiment of the present invention; and

FIG. 2 schematically illustrates a flow chart outlining the steps of the method according to an embodiment of the invention.

### DETAILED DESCRIPTION OF PREFERRED EMBODIMENTS OF THE INVENTION

The present invention will now be described more fully hereinafter with reference to the accompanying drawings, in which a currently preferred embodiment of the invention is shown. This invention may, however, be embodied in many different forms and should not be construed as limited to the embodiments set forth herein; rather, these embodiments are provided for thoroughness and completeness, and fully convey the scope of the invention to the skilled person. Like reference characters refer to like elements throughout.

The present invention will mainly be discussed with reference to components of a wind turbine. It should be noted that this by no means limits the scope of the present invention which is equally applicable to other types of large scale rotating systems.

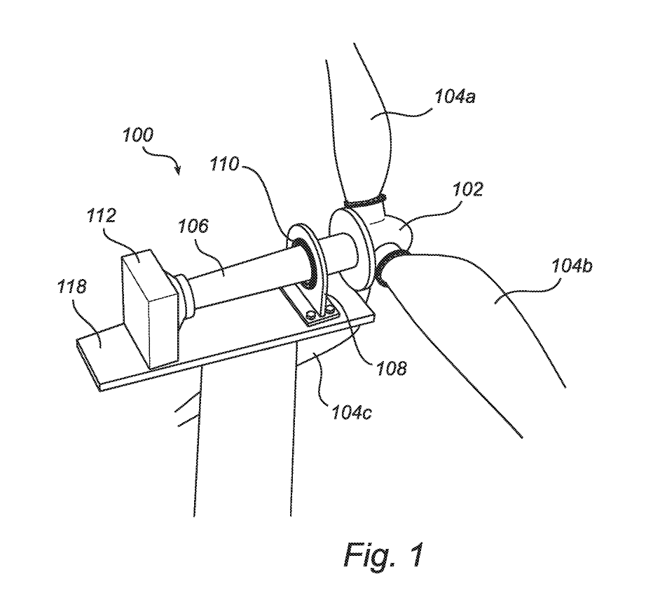

FIG. 1 schematically illustrates portions of a wind turbine 100 where a method and system according to embodiments of the present invention may be used. The wind turbine illustrated in FIG. 1 comprises a hub 102, a plurality of blades 104a-c connected to the hub 102, a main shaft 106 attached to the hub 102, a bearing housing 108 attached to a support structure 118, and a main bearing 110 having an inner ring attached to the main shaft 106 and an outer ring attached to the bearing housing 108. The main shaft 106 is connected to a housing 112 which may comprise a gearbox and a generator.

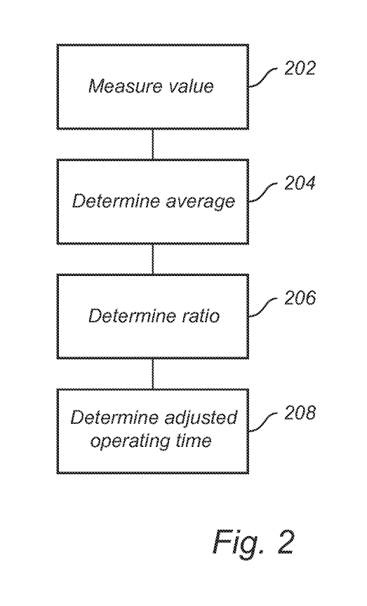

The system further comprises a control unit configured to perform the general steps of the method according to an embodiment of the invention as outlined by FIG. 2.

The control unit may include a microprocessor, microcontroller, programmable digital signal processor or another programmable device. The control unit may also, or instead, include an application specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device.

In a first step 202, a value of an operating characteristic is measured. The value may be measured directly by a sensor connected to the control unit, or it may be determined indirectly as a function of another measured or detected parameter. The value is measured for a predetermined period of time.

Next 204, a time average of the measured value for the predetermined period of time is determined by the control unit.

In the following step 206, the ratio between the determined average value and a predetermined maximum value of the operating characteristic is determined. The maximum value may for example be stored locally in a storage device in connection with the control unit. Thereby, the ratio represents the percentage of the maximum value at which the operating characteristic operates.

In the final step 208, the adjusted operating time is determined as the aforementioned ratio multiplied by the predetermined period time.

As an example, each of the operating characteristics load and rotational velocity may operate at an average of 50% of the maximum value for an hour. This gives an adjusted operating time equal to 0.5×0.5×1=0.25 h. The determined adjusted operating time may then be stored locally, added to a previously stored adjusted operating time or transmitted to a remote storage location or a remote monitoring system to be used for system control and further analysis of the operating conditions of the wind turbine. Furthermore, through the present invention, the specific operational loads which particular components is exposed to can be monitored, thereby making it possible to adapt the service and replacement of components to the actual operating conditions for each component.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A method for determining an adjusted operating time of a component in a rotating system, the method comprising steps of:
during operation of the rotating system, measuring a value of an operating characteristic of a component for a predetermined period of time;
determining an average of the measured value of the operating characteristic for the predetermined period of time;
determining a ratio of the average and a maximum value of the operating characteristic; and
determining the adjusted operating time as the product of the ratio and the predetermined period of time.

2. The method according to claim 2, further comprising steps of:
during operation of the rotating system, measuring a value of a second operating characteristic of a component for the predetermined period of time;
determining a second average of the measured value of the second operating characteristic for the predetermined period of time;
determining a second ratio as the ratio of the second average and a maximum value of the second operating characteristic; and
determining an adjusted operating time as the product of the first ratio, the second ratio and the predetermined period of time.

3. The method according to claim 1, further comprising the a step of:
determining an accumulated adjusted operating time of the component by adding a determined adjusted operating time to a previously determined adjusted operating time.

4. The method according to claim 1, wherein the operating characteristic is a rotational velocity of the component.

5. The method according to claim 1, wherein the operating characteristic is a mechanical load of the component.

6. The method according to claim 1, wherein the operating characteristic is a vibration of the component.

7. The method according to claim 1, wherein the value of an operating characteristic of a component is measured continuously during operation of the rotating system.

8. An arrangement for determining an adjusted operating time of a component in a rotating system, the system comprising:
a sensor configured to detect a value of an operating characteristic of a component; and
a control unit connected to the sensor and configured to:
during operation of the rotating system, acquire a value of the operating characteristic of a component from the sensor for a predetermined period of time,
determine an average of the acquired value of the operating characteristic for the predetermined period of time,
determine a ratio of the average and a maximum value of the operating characteristic, and
determine the adjusted operating time as the product of the ratio and the predetermined period of time.

9. The arrangement according to claim 8, wherein the sensor is adapted for detecting a rotational velocity of the component.

10. The arrangement according to claim 8, wherein the sensor is a sensor adapted for detecting a mechanical load of the component.

11. The arrangement according to claim 8, wherein the sensor is adapted for detecting a vibration of the component.

12. The arrangement according to claim 8, wherein the sensor is an accelerometer.

13. The arrangement according to claim 8, wherein the component is a bearing.

14. The arrangement according to claim 8, further comprising a communication system for transmitting to a remote location, at least one of: the acquired value of the characteristic, the average, the ratio and the adjusted operating time.

15. A wind turbine comprising an arrangement, the arrangement comprising:
a sensor configured to detect a value of an operating characteristic of a component; and
a control unit connected to the sensor and configured to:
during operation of the rotating system, acquire a value of the operating characteristic of a component from the sensor for a predetermined period of time,
determine an average of the acquired value of the operating characteristic for the predetermined period of time,
determine a ratio of the average and a maximum value of the operating characteristic, and
determine the adjusted operating time as the product of the ratio and the predetermined period of time,
wherein the arrangement is adapted to determine an adjusted operating time of a component in a rotating system,
wherein the arrangement is integrated into the wind turbine.
